(19) United States
(12) Patent Application Publication
(10) Pub. No.: US 2014/0374959 A1
(43) Pub. Date: Dec. 25, 2014

(54) INJECTION MOLDING METHOD WITH INFRARED PREHEAT

(71) Applicants: James Peplinski, Ada, MI (US); Scott Powers, Rockford, MI (US)

(72) Inventors: James Peplinski, Ada, MI (US); Scott Powers, Rockford, MI (US)

(21) Appl. No.: 13/926,047

(22) Filed: Jun. 25, 2013

(51) Int. Cl. B29C 45/73; B29C 45/17

(52) U.S. Cl. CPC B29C 45/73; B29C 45/7306; B29C 45/1706
USPC 264/402; 425/144; 264/572; 264/40.6

(57) ABSTRACT

A plastic injection molding system includes a mold having an interior surface and an exterior surface. The interior surface defines a mold cavity, which is configured in a shape of a part to be formed. A source of plastic, having a known heat distortion temperature, is injected into the mold cavity. At least one infrared heat source is disposed adjacent the mold. The at least one heat source is moveable between a first position disposed away from the interior surface of the mold and a second position where the at least one heat source is in communication with the mold cavity surface. A controller is in communication with the at least one heat source and is configured to heat the mold cavity surface to a predetermined temperature below the heat distortion temperature of the plastic resin. At least one temperature sensor in is communication with the interior surface of the mold and in communication with the controller to move the at least one heat source to the second position when the interior surface of the mold reaches the predetermined temperature.

### TECHNICAL FIELD

The present disclosure relates generally to an injection molding method. More specifically, the present disclosure relates to an injection molding method, for cosmetic parts, where the mold cavity is pre-heated prior to plastic injection.

### BACKGROUND OF THE INVENTION

Plastic molded articles are well known. Similarly, injection molding processes for forming these molded plastic articles are also well known. According to conventional injection molding processes, a molten plastic material is injected into a mold having a cavity in the shape of the part to be formed. Once the molten plastic has filled out the mold cavity and has sufficiently cooled, the mold can be opened and the molded part removed.

Injection molding processes for forming hollow plastic parts are also well known. According to these processes, an inert gas is injected into the molten plastic stream as it is injected into the mold. The gas helps the molten stream fill out the mold cavity and also helps to pack the plastic against the mold surface as it cools to provide an improved molded surface. Injection molding processes can provide significant benefits for certain types of parts as they require less plastic to form the part, which can decrease the cost of manufacture. Additionally, because the gas within the part can exert a pressure on the plastic driving it against the mold surface, the quality of the finished part surface can be improved with respect to sinks and similar molding defects. However, this does nothing for flow-related defects such as knit-lines, blush, or splay. Further, the utilization of less plastic decreases the time for the part to cool, which can improve cycle time.

One common method for injection molding involves injecting an inert gas into the melt stream. These gas assist injection molding methods provide benefits in that the presence of the gas decreases the amount of resin needed to form the part. This also reduces the weight of the part as well as the cost of manufacturing. However, this process can produce a cosmetic molding defect known as splay on the cavity surface of the molded part. Additionally, this process does nothing for flow-related defects such as knit-lines and blush. Since the quality of the injection molded articles can be impacted by the temperature of the mold, processes have tried heating the mold before the plastic is injected to improve part quality. One known process heats the mold to a temperature above the heat deflection temperature of the resin being injected into the mold. While this provides benefits and is effective for reducing the splay, knit-lines, and blush to an acceptable cosmetic level, it is not optimized for cycle time impact as a result of this added mold-heating process step.

Present heating methods known in the art for pre-heating the mold typically utilize cartridge heating, hot air convection heating, water and/or steam heating, and electromagnetic induction coil heating. Specifically, these methods can be inefficient at properly heating the die cavity in a safe and reliable manner, which can negatively impact cycle time. Additionally, these methods do not offer consistent and uniform heating across the surface of the die itself, which can ultimately lead to surface defects in the final product.

### SUMMARY OF THE INVENTION

It is therefore an aspect of the present disclosure to provide an improved process for forming a plastic molded part that yields a better quality surface finish.

It is a related aspect of the present disclosure to provide an improved process for forming a plastic molded part having one or more cosmetic surfaces.

It is another aspect of the present disclosure to provide an improved process for forming a plastic molded part that pre-heats the interior surface of the mold so as to minimize the impact on cycle time while reducing any surface defects.

According to the above and the other aspects, a plastic injection molding process is provided. According to the process, a mold is provided having a cavity in the shape of a part to be formed. The mold cavity also has an interior surface which is configured to contact a molten plastic that is injected into the mold. The process includes placing a heat source into communication with the interior surface of the mold. The heat source may heat the interior surface of the mold to a desired temperature which is below the heat distortion temperature of the resin material to be injected into the mold. Upon an indication that the interior surface of the mold cavity has reached the desired temperature, the mold is closed and molten resin is injected into the mold cavity. An inert gas may also be introduced into the resin as the resin is injected in the mold die. The molten resin fills out the mold and is allowed to cool. The molded part can then be removed from the mold. The heating system is configured to uniformly heat the interior surface of the mold cavity such that the resultant molded part has improved cosmetics for blush, sinks, knit-lines and splay on the surface.

According to another aspect of the disclosure, an injection molding system includes a heating system for heating an interior surface of a mold cavity. The heating system can include a plurality of heat sources that are coupled together. The heating system is translatable between a retracted position where it is removed from communication with the interior surface of the mold and a heating position, where it is in communication with the interior surface of the cavity. The heating system is coupled to a controller and configured to emit heat at a level such that the mold cavity is heated to a temperature below the heat distortion temperature of the resin to be injected into the mold. The heating system is configured to uniformly heat the interior surface of the mold cavity such that the resultant molded part has improved cosmetics for blush, sinks, knit-lines and splay on the surface. One or more temperature sensors may be in communication with the mold surface to monitor its temperature and relay it to the controller.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a schematic illustration of an injection molding machine in accordance with an aspect of the disclosure;

FIG. 2 is a schematic illustration of a mold in an open position with a heat source applying heat to a mold cavity in accordance with an aspect of the disclosure;

FIG. 3 is a schematic illustration of a mold in a closed position in accordance with an aspect of the disclosure;

FIG. 4 is a schematic illustration of a mold half in an open position in accordance with an aspect of the disclosure;

FIG. 5 is a schematic illustration of a mold half with a heat source applying heat to a mold cavity in accordance with an aspect of the disclosure;

FIG. 6 is a perspective view of grill assembly and fascia for a vehicle in accordance with an aspect of the disclosure; and

FIG. 7 is an enlarged broken away view of the grill assembly and fascia of FIG. 6.

### DETAILED DESCRIPTION OF THE DISCLOSURE

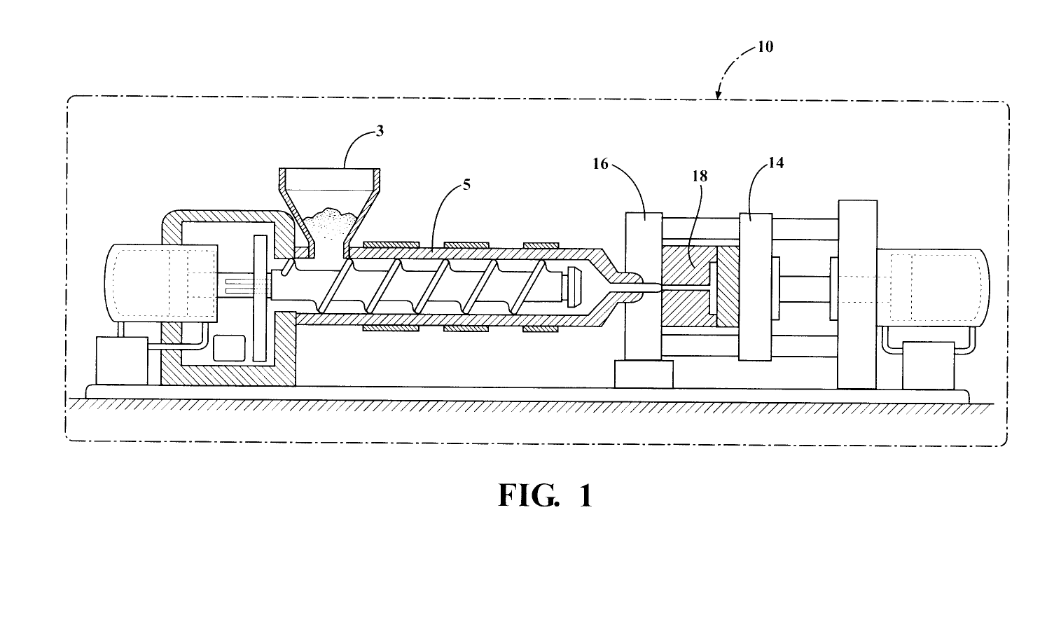

The present disclosure relates to a method and system for injection molding a plastic part. According to an aspect as shown in the Figures and with specific reference to FIG. 1, the system 10 can include conventional injection molding equipment, including a hopper 3 or other storage device for receiving and housing plastic pellets, an injection barrel 5 into which the plastic pellets are inserted and then heated to a molten plastic, and a mold 12 into which the molten plastic is injected. According to an aspect, the resin may be an engineered resin. However, other resins may also be employed. The mold 12 can include two mold halves, namely a moveable platen 14 and a stationary platen 16 that when moved into engagement can form a closed mold cavity 18. The mold cavity 18 may be formed in the shape of the part to be molded. It will be appreciated that the configuration of the injection molding equipment and the mold can vary and is not critical to the present disclosure. For example, the mold can include a plurality of cavities such that multiple parts can be formed with each plastic injection cycle. The system 10 can also include a supply 30 of inert gas that injects gas through a pin into the mold 12 or into the molten plastic in the barrel 5.

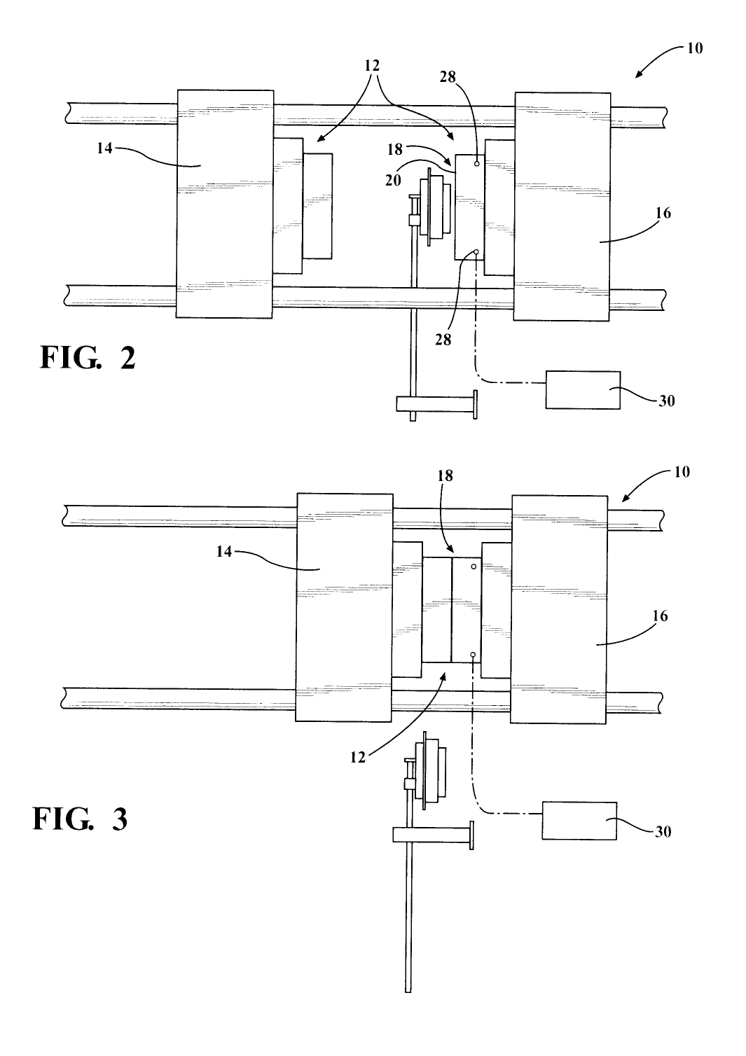

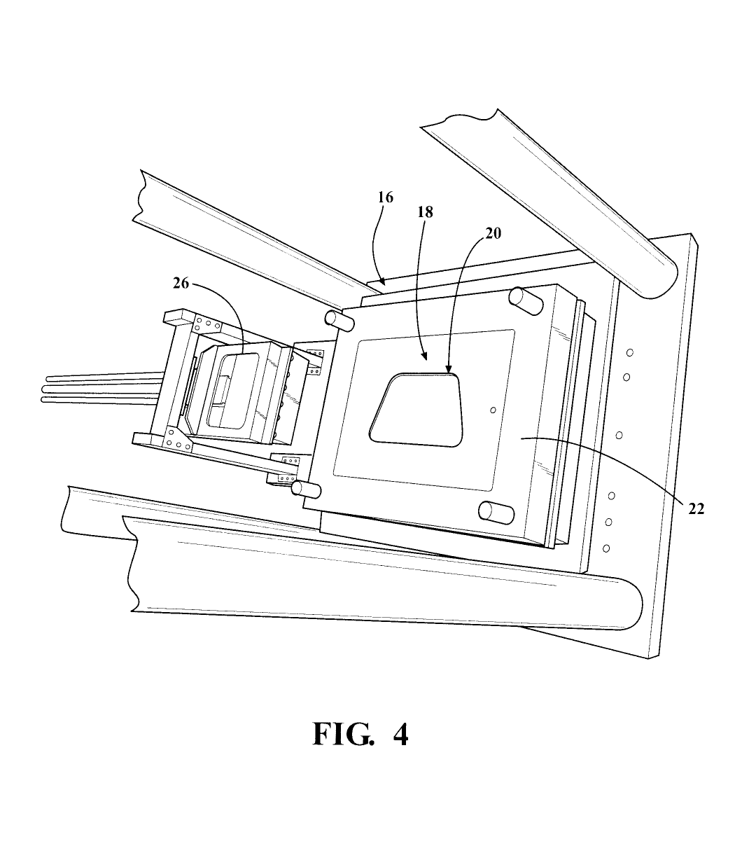

With reference to FIG. 4, the mold cavity 18 can include an interior surface 20, which is configured to contact the molten plastic. According to an aspect, the mold cavity 18 may be disposed in a cavity holder block 22. The mold cavity 18 may also be isolated for efficient heating as will be understood by one of ordinary skill According to another aspect, the system 10 can include a heat source 26. As shown in FIGS. 3 and 4, the heat source 26 may be disposed in a retracted position where it does not provide any heat to the mold cavity 18. When the heat source 26 is in the retracted position, the mold halves 14, 16 may be moved together and clamped to form the mold cavity 18, as shown schematically in FIG. 3. According to an aspect, the heat source 26 may be moveable from the retracted position to a heating position. According to a further aspect, in the heating position, the heat source 26 may be disposed a predetermined distance away from the interior surface 20 of the mold cavity 18, as is schematically shown in FIGS. 2 and 4.

According to a further aspect, the heat source 26 may be a single infrared (IR) heat source. According to another aspect, the heat source 26 may consist of a plurality of IR heat sources, which may be configured as a bank that can be moved collectively into and out of communication with the interior surface 20 of the mold 12. According to a still further aspect, the bank of heat sources 26 may be configured to heat the interior surface 20 of the mold cavity 18 to a predetermined temperature, which temperature is below the heat distortion temperature of the resin material to be injected into the mold cavity 18. It will be appreciated that the heat source 26 and the heat source bank may take on a variety of different configurations. According to an aspect, the heat sources 26 can heat only the interior surface of the mold and no other portions of the mold. This can provide and very efficient method.

According to another aspect of the disclosure, a plurality of temperature sensors 28 may be employed to monitor the temperature of the interior surface 20 of the mold cavity 18. The temperature sensors 28 may be disposed under an interior surface of the mold cavity 18. The temperature sensors 28 may also be in electrical communication with the heat source 26 such that when the interior surface 20 of the mold cavity 18 has reached the predetermined temperature, the heat source 26 may be deactivated or retracted. According to an aspect, this ensures that the predetermined mold temperature is not exceeded. According to a related aspect, the temperature sensors 28 ensure that the heat sources 26 do not heat the mold cavity 18 to a temperature that exceeds the predetermined mold temperature thus minimizing cycle time impact. It will be appreciated that any number of temperature sensors 28 may be employed and they may be disposed in a variety of different locations.

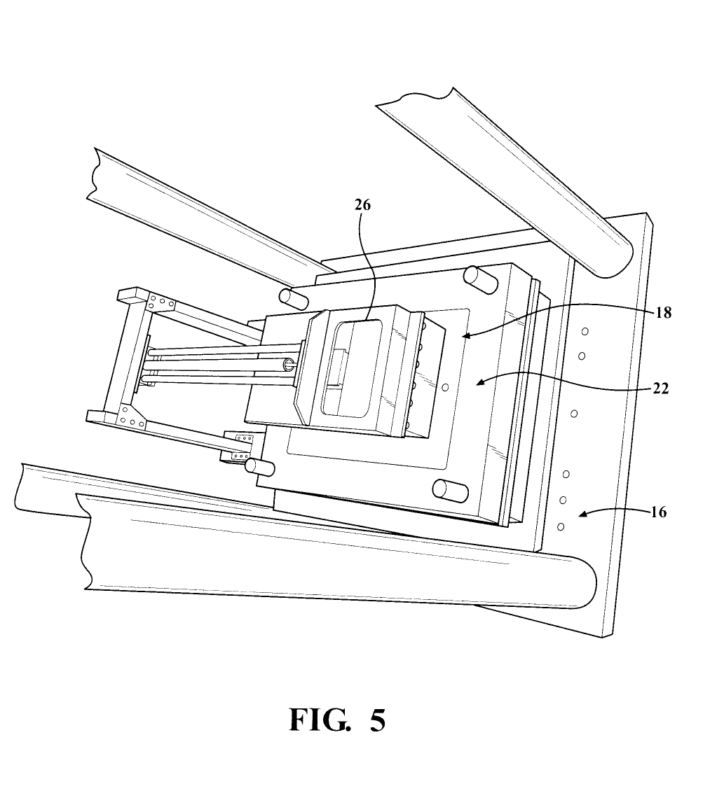

As shown in FIG. 4, the heat source 26 may be disposed remotely from the mold cavity 12. According to a further aspect, the heat source 26, such as an IR heat source may be moved into a heating position, shown in FIG. 5. Once the heat source 26 is moved to the heating position, heat is selectively applied to the mold surface 20 such that it is uniformly heated to a predetermined temperature, which temperature, according to an aspect, is below the heat distortion temperature of the resin to be injected into the mold. According to an aspect, the use of an IR heat source may allow the interior surface 20 of the mold cavity 18 to be heated uniformly across its entire surface area staying below the material heat deflection temperature. According to another aspect, the heat source bank may be contoured such that each point on the heat source bank is relatively equidistant from the adjacent point on the interior surface 20 of the mold cavity 18. This allows the interior surface of the mold die to be heated evenly and equally, which reduces cosmetic defects in the final product.

According to an aspect, the temperature sensors 28 can provide feedback and signal a controller to move the heat source 26 to a retracted position when the interior surface 20 of the mold cavity 18 has been heated to the predetermined temperature. Thereafter, the molten plastic is injected into the mold 12 in a quantity sufficient to fill out the mold cavity 18 and form the part. Additionally, according to an aspect, an inert gas may be introduced into the resin as the resin is injected in the mold cavity 18. Alternatively, the insert gas may be injected directly into to mold cavity 18, as will be understood by one of ordinary skill in the art. The inert gas may be nitrogen, however, a variety of other suitable gases may also be employed, such as helium, argon, and CO2. The introduction of an inert gas into the resin can reduce the part density by creating a porous core structure inside the mold as will be appreciated by one of ordinary skill in the art. The introduction of an inert gas, coupled with the IR heating of the interior surface of the mold die to a temperature below the heat deflection temperature of the resin, eliminates the cosmetic problems discussed above.

Additionally, a method for injection molding a plastic part with IR preheating is provided. According to an aspect, the mold halves 14, 16 are opened to expose an interior surface 20 of the mold cavity 18. A controller may then actuate a robotic arm 32 to move the heat source 26 from a location adjacent the mold 12 to a heating position disposed adjacent the interior surface 20 of the mold cavity 18. According to an aspect, in the heating position, the heat source 26 is disposed a fixed predetermined distance away from the mold surface. The heat source 26 may then be energized to pre-heat the interior surface 20 of the mold cavity 18 to a predetermined temperature, i.e., below the heat distortion temperature of the resin to be injected into the mold. It will be appreciated that the predetermined temperature may be a variety of suitable temperatures based on the resin being injected.

According to an aspect, the plurality of temperature sensors 28 monitor the temperature of the interior surface 20 of the mold cavity 18 as the heat source is applying heat thereto. When the temperature of the interior surface 20 reaches the predetermined temperature, the temperature sensors 28 may signal the controller. The controller may then actuate the robotic arm 32 to retract the heat source 26 to a retracted position away from the mold cavity 18. The moveable platen 14 may then be moved into engagement with the stationary platen 16. Once the mold 12 is closed, the controller may then cause molten resin to be injected into the mold and into communication with the pre-heated interior surface 20 of the mold cavity 18. Additionally, an inert gas can be injected into the resin to help pack out the mold. The molten resin can then fill out the mold cavity 18 and can then be allowed to cool. Once the molded part has cooled, the mold 12 may be opened by moving the moveable platen 14. The molded plastic part may then be ejected such as by ejector pins or other suitable mechanism as is known in the art. The heat source 26 can then be moved into a heating position adjacent the interior surface 20 of the mold cavity 18 for the next cycle.

To optimize the time spent heating the cavity of the mold, the cavity is isolated from anything which could serve as a heat sink. Such things could be the mold platen and cooling methods (water, air, chilled gas) in some form of contact with the mold. Methods for isolation of the mold cavity can be varied. Isolation of the cavity further minimizes the impact on the molding cycle from heating the cavity surface.

In accordance with an aspect, the method may be utilized to form plastic parts with decorative surfaces. More specifically, the present method may be utilized to mold parts with class A automotive surfaces. Additionally, in accordance with an aspect the method may be employed to form parts in color. Moreover, the method may be employed to form parts having one or more surfaces that are to be metal plated or A-Gloss painted. According to a specific example of the disclosure, the method may be employed to form plastic grilles for attachment to a vehicle fascia to enhance vehicle aesthetics. According to this specific method, the plastic grille may be subject to metal plating processes, such as chrome, nickel or copper plating. According to another aspect, the metal plating process consists of multiple metal layers. It will also be appreciated that the method may be employed to form a variety of different parts.

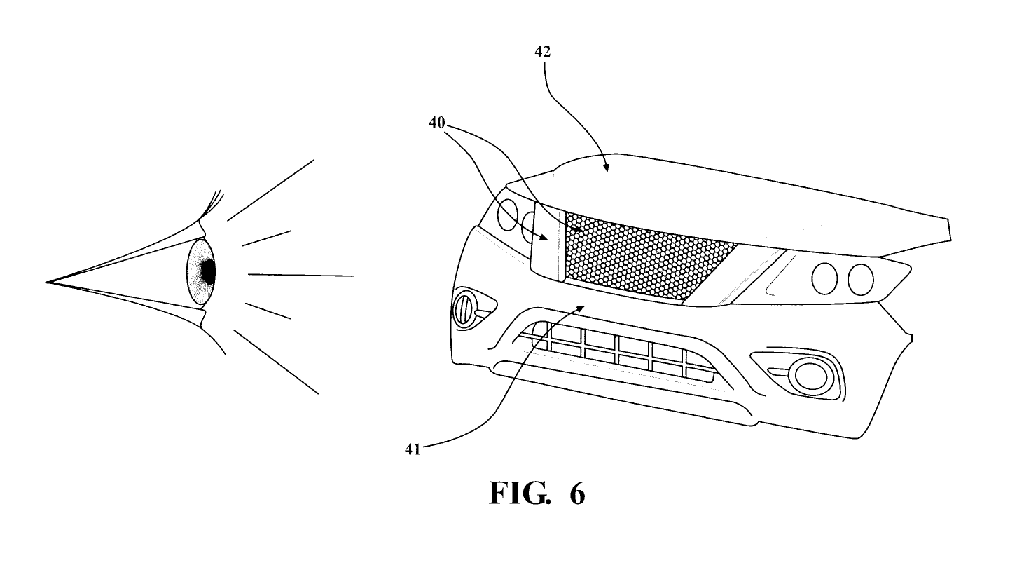

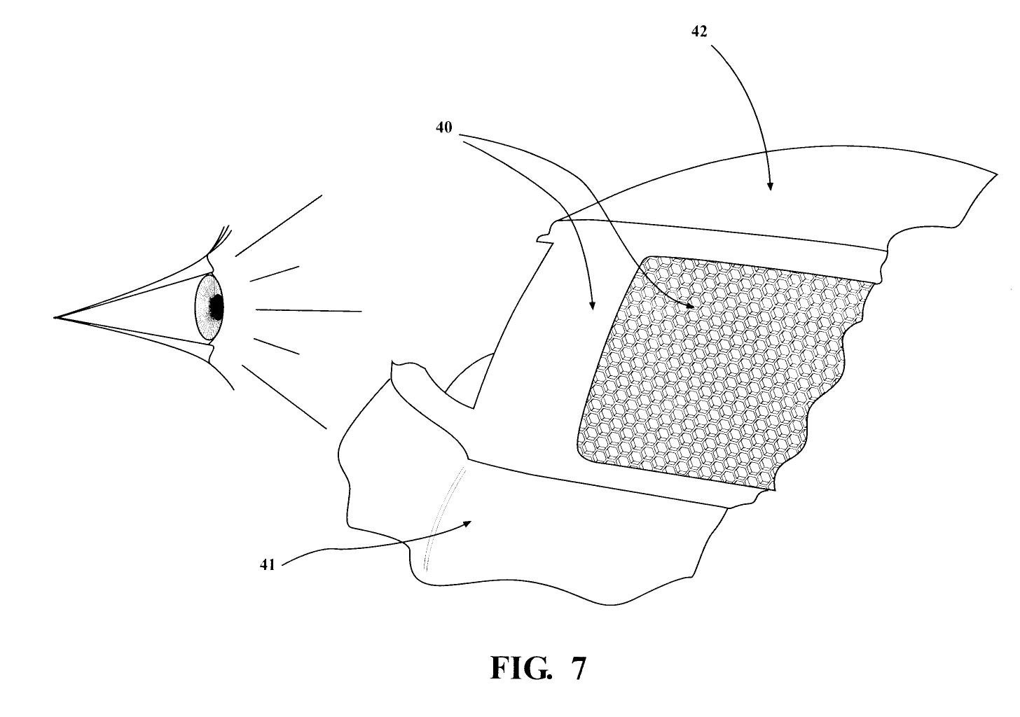

FIGS. 6 and 7 illustrate a vehicle grille 40 for attachment to a fascia 42 of a vehicle 44 according to an aspect. As shown the vehicle grill is formed in accordance with the method above and is subjected to a metal plating process to provide an attractive decorative surface. As shown best in FIG. 6, the outermost surface of the grill 40 is the class A surface that is improved according to the present disclosure. The area between the openings is not normally visible need not have the same cosmetic benefits as the outermost surface. The fascia 42 and the vehicle hood 46 are other exemplary class A surfaces that can be formed in accordance with the present disclosure. Other plastic molded parts that can be formed in accordance with the present disclosure include other vehicle trim components, such as wheel covers and the like.

Note that not all of the activities described above in the general description or the examples are required, that a portion of a specific activity may not be required, and that one or more further activities may be performed in addition to those described. Still further, the orders in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. A plastic injection molding system, comprising:
a mold having an interior surface and an exterior surface;
a mold cavity defined by the interior surface and configured in a shape of a part to be formed;
a source of plastic resin to be injected into the mold cavity, the source of plastic resin having a heat distortion temperature;
at least one infrared heat source disposed adjacent the mold, the at least one heat source being moveable between a first position disposed away from the interior surface of the mold and a second position where the at least one heat source is in communication with the mold cavity surface;
a controller in communication with the at least one heat source and configured to heat the mold cavity surface to a predetermined temperature below the heat distortion temperature of the plastic resin;
at least one temperature sensor in communication with the interior surface of the mold and in communication with the controller to move the at least one heat source to the second position when the interior surface of the mold reaches the predetermined temperature.

2. The system of claim 1, further comprising:
a plurality of infrared lamps configured a heat source bank.

3. The system of claim 2, wherein the heat source bank is contoured to match a contour of the mold cavity.

4. The system of claim 1, further comprising:
an inert gas to be injected into the mold along with the resin.

5. The system of claim 4, wherein the inert gas is nitrogen.

6. A plastic injection molding method comprising:
providing a mold having an interior surface and an exterior surface, the interior surface defining a cavity in a shape of a part to be formed, the mold having an open position and a closed position;
placing a heat source in communication with the interior surface of the cavity;
heating the interior surface of the cavity to a predetermined temperature, which predetermined temperature is below a heat distortion temperature of a resin to be injected into the mold;
removing the heat source from communication with the interior surface of the cavity when its temperature reaches the predetermined temperature;
closing the mold;
injecting molten resin into the cavity; and
utilizing an inert gas as part of the molding process.

7. The method of claim 6, wherein the heat source consists of an infrared source.

8. The method of claim 7, further comprising:
a plurality of infrared sources configured as a heat source bank.

9. The method of claim 8, further comprising:
positioning the heat source bank a fixed distance from the interior surface to uniformly heat the mold cavity.

10. The method of claim 6, further comprising:
monitoring the temperature of the interior surface of the mold.

11. The method of claim 6 wherein the inert gas is nitrogen.

12. A method of forming a decorative grille for a vehicle fascia, comprising:
forming a mold cavity in a shape of a grille for attachment to a vehicle fascia;
selecting a resin from which to form the decorative grille, the resin being configured to receive a metal plated layer thereon after formation of the grille;
placing an infrared heat source in close proximity to an interior surface of the mold cavity;
heating the interior surface of the mold cavity to a predetermined temperature, which predetermined temperature is below a heat deflection temperature of the selected resin;
closing the mold;
injecting the resin into the mold cavity to form the grille;
ejecting the cover from the mold cavity; and
plating a metal layer on an outboard surface of the grille to form the decorative cover.

13. The method of claim 12, further comprising:
utilizing an inert gas as part of the molding process.

14. The method of claim 12, wherein the metal layer consists of one of a chrome, copper or nickel metal.

15. The method of claim 12, further comprising:
a plurality of heat sources configured as a heat source bank.

16. The method of claim 15, further comprising:
positioning the heat source bank a fixed distance from the interior surface to uniformly heat the mold cavity.

17. The method of claim 12, further comprising:
monitoring the temperature of the interior surface of the mold cavity.

18. The method of claim 13, wherein the inert gas consists of nitrogen.
